(19) United States
(12) Patent Application Publication
(10) Pub. No.: US 2007/0248757 A1
(43) Pub. Date: Oct. 25, 2007

(54) Processes for producing materials containing reduced abrasion titanium dioxide pigment

(76) Inventor: Kostantinos Kourtakis, Media, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/408,683

(22) Filed: Apr. 20, 2006

(51) Int. Cl. B05D 5/00; C09C 1/36; C09D 11/00

(52) U.S. Cl. 427/256; 106/437; 106/447; 106/31.9

(57) ABSTRACT

Processes for producing titanium dioxide pigment are provided. The processes provide pigments having reduced abrasiveness as compared to titanium dioxide pigments made using conventional processes. The processes include heating titanium dioxide in a non-oxidizing atmosphere to 800 to 1200° C. to produce a reduced abrasion pigment.

### FIELD OF THE INVENTION

The present invention is directed to processes for producing titanium dioxide pigments having reduced abrasiveness in comparison to titanium dioxide pigments made using conventional processes.

### BACKGROUND

Titanium oxide pigments can be used for can coating, printing inks, fiber, paper, fiber and other applications. Titanium oxide can also be used in electrode materials and in thin film structures. Commercial processes for the manufacture of TiO2 pigment include processes in which a titanyl sulfate precursor is converted to the oxide form under mild conditions; and the oxidation of titanium chloride at high temperatures. Titanium oxide can be used as an electrode material, as disclosed by Sekisui Chemical Company (JP51117978) wherein an electrode comprising titanium dioxide which is calcined at high temperature in an atmosphere without oxygen. Bujard et al (WO2004065295) describe a process for the production of porous inorganic materials with high uniformity of thickness and/or high effective surface area. Okuda et al (U.S. Pat. No. 5,320,782) describe acicular or platy titanium suboxides which are capable of retaining their native configurations during reduction. Kawatetsu Kogyo (JP 05017148) describes a material consisting of fibrous titanium oxide fine particles with a film of partially reduced tin oxide.

There is a need for low abrasion grade titanium dioxide in can coating and printing ink applications and products such as pigment containing fibers. A reduced abrasion titanium oxide pigment is desirable as an ingredient in inks used in can coating processes, for example by gravure printing, and for ink jet printing. Pigments are sought which will prolong the useful lifetime of ink jet printing equipment and engraved plates used in gravure printing.

The processes disclosed herein can be used to manufacture an ink containing titanium dioxide pigment which exhibits reduced abrasion.

### SUMMARY OF THE INVENTION

One aspect of the present invention is a process comprising
a) heating particles of titanium dioxide to 800 to 1200° C. for about 5 to 24 hours in an atmosphere comprising a non-oxidizing gas to form a heat treated pigment
b) mixing said heat treated pigment with other ink components to form an ink.

### DETAILED DESCRIPTION

In ink jet processes, an ink is contained in a reservoir. The reservoir has an aperture at one end and a piezoelectric actuator at another end. The motion of the actuator forces ink from the reservoir through the aperture in the form of drops of ink. The drops of ink are directed to fall on the desired substrate. The substrate or ink jet reservoir can be translated to form a desired pattern. The abrasiveness of the pigment can impact the quality of the printing. Abrasive pigments lead to wear of the aperture. Wear of the aperture to turn leads to nonuniformity of the ink drops and degradation of the printed pattern.

In gravure, a pattern is engraved in a plate. An ink is applied to the plate, filling the engraved pattern. The inked plate is then pressed against a desired substrate and the pattern of ink is transferred to the substrate. An abrasive pigment can lead to wear of the engraved pattern on the plate. This in turn leads to distortion of the printed image after numerous printing cycles. Less abrasive pigments such pigments made according to the processes of the present invention can lead to less pattern distortion and better printing quality after numerous printing cycles.

The present invention provides processes for making titanium dioxide pigments. The pigments have reduced abrasiveness as compared to titanium dioxide pigments made using conventional processes. In some embodiments, the reduced abrasion pigments can be included in polymer fibers. The present inventor has found that titanium oxide pigment that is heated in a non-oxidizing atmosphere becomes substantially less abrasive than titanium dioxide pigment made using conventional processes.

In one embodiment, a process includes heating titanium dioxide in a non-oxidizing atmosphere to 800 to 1200° C. for a period of 5 to 24 hours to produce a heat treated pigment. The non-oxidizing atmosphere comprises a non-oxidizing gas. In some preferred embodiments, the non-oxidizing gas contains, a gas selected from nitrogen, helium, argon and mixtures thereof. Desirably, the gas consists essentially of one or more gases selected from nitrogen, helium, and argon. A non-oxidizing gas, as the term is used herein, is a gas that will not maintain the tetravalent oxidation state of the titanium cation in the oxide. Metal oxides, such as TiO₂, are reducible and can form a homologous series of oxygen deficient phases, the Magneli phases of the type TiₙO₂ₙ₋₁, where n can vary from about 1 to a large number such as 50 or greater (when n is large, it approaches TiO₂ as disclosed in, for example p. 140, Solid State Chemistry, Smart and Moore, Chapman Hall, 1992.) The non-oxidizing gas can contain up to 5 ppm of oxygen, preferably up to 2 ppm oxygen. In addition to the inert gases (N₂, He, and Ar) other non-oxidizing gases that can be used include CO, H₂, and N₂O. The heating can be performed in any controlled-atmosphere heating device wherein oxygen can be substantially or entirely excluded. For example, tube furnaces, rotary tube furnaces, vertical fluidized beds or other similar devices can be used for the heating cycle. The pigment can optionally contain silicon or other halide co-oxidants introduced during manufacture of the pigment by the chloride process.

The heat treated titanium dioxide pigment is mixed with other components to form an ink, which may be used in printing processes such as ink jet or gravure

Flexographic, rotogravure and jet inks are described in the Kirk-Othmer Encyclopedia of Chemical Technology (John Wiley and Sons Inc.) The inks comprise colorants such as pigments and/or dyes and other ink constituents. Such inks can be made using pigments that are prepared according to the processes disclosed herein. Other ink constituents include resins, solvents and additives.

The resins impart adhesion and end use resistance properties to the ink film. Resins are polymers that can be film formers or nonfilm formers. Film formers are flexible and form a continuous film when dry. Some resins require the use of an additive such as a plasticizer to achieve film formation. Non film-forming polymers are brittle polymers that do not form a film even with plasticizers. Plasticizers are nonvolatile liquids or soft resins which may partially dissolve the main resins. Resins for flexographic ink are soluble in solvents that do not harm the printing plate. Resins for gravure ink do not need such solubility because they are used with a metal gravure plate cylinder.

Pigments are preferably insoluble in the solvent and the resin. Pigments must be mechanically dispersed in the other ink constituents.

Solvents are used for two reasons. First, a solvent dissolves the resin, resulting in an ink having a viscosity that is suitably low for printing. Second, the solvent desirably evaporates quickly and completely from the printed film. Historically, there are 10 gravure ink types categorized by the binders or solvents used: aliphatic hydrocarbon, aromatic hydrocarbon, nitrocellulose, polyamide resins, SS nitrocellulose, polysyrene, chlorinated rubber, vinyls, water-based and miscellaneous.

The principal families of solvents used in making inks are alcohols, esters, ketones, glycols and water. The principal families of resins used in making inks are cellulosic, vinylic, acrylic and polyamide polymers. Additives can be used to confer specific properties to the ink such as, for example, a desired rheology, adhesion, abrasion, and/or scratch resistance.

Several types of ink jet inks are known. An example of an ink composition containing a titanium oxide pigment, which can be used in the methods disclosed herein, is disclosed in WO 2006/009759 which is hereby incorporated herein by reference. The ink comprises titanium dioxide, a combination of dispersants being a graft copolymer and a block copolymer and a liquid carrier. The liquid carrier is water glycol ether and mixtures thereof. The composition disclosed in WO 2006/009759 can also contain a third dispersant, e.g., a phosphated acrylic copolymer. The composition can also contain other dispersants, humectants and rheology modifiers when used in the methods disclosed herein. Kondo in US 2005/0146544, which is hereby incorporated herein by reference, discloses a white ink containing a white pigment, a polymerizable compound and a polymerization initiator. US 2004/00024091, which is hereby incorporated herein by reference, discloses a UV curable white ink composition containing titanium dioxide, a polymeric dispersant, a photopolymerizable compound and a photopolymerizable initiator. Tanabe in U.S. Pat. No. 6,989,054 discloses a white ink composition containing water and surface treated titanium dioxide. The titanium dioxide is surface treated with an inorganic phosphoric acid compound.

Organic solvent systems can also be used in the methods and compositions disclosed herein. US 2004/0110868, which is hereby incorporated herein by reference, discloses an ink containing one or more organic solvents, one or more white pigments, one or more hydrophobic conductive agents and one or more binder resins. Additionally, solventless ink systems such as disclosed in WO 00/49097, which is hereby incorporated herein by reference, can be used with the heat treated pigments disclosed herein. The disclosed composition contains titanium dioxide and a vehicle containing a polymerizable component essentially free of solvents.

Titanium dioxide pigments for use in the present processes can be made using the chloride process, which is well known to those skilled in the art. The process is well known and described, for example, in U.S. Pat. Nos. 2,488,439 and 2,559,638 which are incorporated herein by reference. The addition of silicon halide to the silicon tetrachloride prior to oxidation is described in U.S. Pat. No. 5,562,764 which is incorporated herein by reference.

In the chloride process, titanium tetrachloride derived from chlorinating titanium ore is evaporated and heated in the vapor phase to temperatures of from about 300 to about 650 C and introduced into a reaction zone of a reaction vessel. Aluminum halide is also mixed with the titanium chloride stream. The aluminum halides, as AlCl₃, AlBr₃, and AlI₃, preferably AlCl₃, are mixed with the titanium chloride in amounts sufficient to provide about 0.2 to about 10 weight % Al2O3, preferably about 0.5 to about 5 weight %, and more preferably about 0.5 to about 2 weight %, based on total aluminum and titanium-containing solids formed (i.e., 100 times (Al₂O₃/(Al₂O₃+TiO₂)) in the oxidation reaction. The oxidation reaction to produce the oxide phases occurs because an oxygen containing gas is introduced into a reaction zone through a separate inlet. The aluminum halide is thoroughly mixed with titanium tetrachloride prior to its introduction into a reaction zone of a reaction vessel. In alternative embodiments, the aluminum halide can be added with various proportions of another halide, such as silicon halide. An oxygen containing gas preferably comprising hydrogen in the form of H2O can range from about 0.01 to 0.3 wt. % hydrogen based on titanium dioxide produced, preferably 0.02-0.2 wt. %, is preheated to at least 1200° C. and is continuously introduced into the reaction zone through a separate inlet from an inlet for the titanium tetrachloride feed stream. Optionally, the oxygen containing gas can also contain a vaporized alkali metal salt such as inorganic potassium salts, or organic potassium salts, to act as a nucleant and for particle size control Particularly preferred salts include CsCl and KCl.

Optionally, a silicon halide can be added to the reaction vessel downstream from the TiCl₄ stream addition. The exact point of silicon halide addition will depend on the reactor design, flow rate, temperatures, pressures and production rates, but can be determined readily by testing to obtain substantially anatase-free TiO₂ and the desired affects on agglomeration and particle size. For example, the silicon halide can be added at one or more points downstream from where the TiCl₄ and oxygen containing gas are initially contacted. Specifically, the temperature of the material during its being converted to oxide form, at the point or points of silicon halide addition, will range from about 1200° C. to about 1600° C., preferably about 1400° C. to about 1600° C. at a pressure of about 5-100 psig, preferably 15-70 psig and more preferably 40-60 psig. Often, the point or points of addition of the silicon halide will not exceed the downstream distance traveled by the other reactants or reaction products by about 0.002 to about 2 seconds, preferably about 0.005 to about 0.3 seconds, after the initial contact of the reactants. Suitable silicon halides include SiCl₄, SiBr₄, and SiI₄, preferably SiCl₄. The silicon halide can be introduced as either a vapor or liquid. In a preferred embodiment, the silicon halide is added downstream in the conduit or flue where scouring particles or scrubs are added to minimize the buildup of TiO₂ in the interior of the flue during cooling, as in U.S. Pat. No. 2,721,626, the disclosures of which are incorporated herein by reference. In this embodiment, the SiCl₄ can be added alone or at the same point with the scrubs. In liquid SiCl₄ addition, the liquid is dispersed finely and vaporizes quickly.

The silicon halide that is optionally added becomes incorporated as silica and/or a silica mixture in the TiO₂. The silica and/or silica mixture is dispersed in the TiO₂ particles and/or on the surface of TiO₂ as a surface coating. Often, the silicon halide will be added in an amount sufficient to provide from about 0.1 to about 10% SiO₂, preferably about 0.5 to 5% SiO₂ and more preferably about 0.5 to 3% SiO₂ by weight based on total TiO₂ and/or SiO₂ solids formed in the oxidation reaction. Feeding SiCl₄ downstream after TiCl₄ and O₂ are initially contacted assists in rutile formation, controls particle size and limits agglomeration.

As a result of mixing of the reactant streams, substantially complete oxidation of TiCl₄, AlCl₃ and SiCl₄ takes place, but for conversion limitations imposed by temperature and thermochemical equilibrium. Solid particles of TiO₂ form. The reaction product containing a suspension of TiO₂ particles in a mixture of chlorine and residual gases is carried from the reaction zone at temperatures considerably in excess of 1200° C. and is subjected to fast cooling in the flue. The cooling can be accomplished by any conventional methods known in the art, including methods described hereinabove. The TiO₂ pigment is recovered from the cooled reaction products by conventional separation treatments, such as, for example cyclonic or electrostatic separating media, or filtration through porous media.

Regardless of the method used to form the titanium oxide, the recovered TiO₂ pigment is then collected and heated to 800 to 1200 C for a period of 5 to 24 hours in a furnace while blanketed with a non-oxidizing gas.

It has been found that pigments produced by the present processes, which include heating in the presence of a non-oxidizing gas, exhibit reduced abrasion compared with TiO₂ pigments made using conventional processes. By “reduced abrasion”, as the term is used herein with regard to inks containing titanium dioxide pigments, is meant an ink containing TiO₂ pigment showing lower substrate (abrasive) weight loss using the Daetwyler method after 500,000 revolutions. The Daetwyler abrasion test is well known to those skilled in the art, and examines the abrasion characteristics of a printing ink on a chrome-plated copper substrate under laboratory conditions representative of industrial gravure printing applications. The method uses a Daetwyler Abrasion Tester AT II (available from the Max Daetwyler Co., Huntersville, N.C.). This method can be used to rank the relative abrasion characteristics of TiO₂ grades. Abrasion is determined by measuring weight loss of the substrate after 500,000 revolutions in the presence of a TiO₂-containing ink. The test is performed as follows. Weighing of the substrate is performed before assembling the Daetwyler instrument. An ink is then prepared according to Table 1 from the TiO₂ sample to be measured.

TABLE 1
Ink formula for abrasion testing

| Ingredient | Grams |
|---|---|
| Burnoc 18-472 Resin* | 240 |
| Methyl Ethyl Ketone | 48 |
| Toluene | 48 |
| Titanium Dioxide | 240 |
| The ingredients are split between two one-quart friction | |
| top cans and 220 grams of 0.2 mm glass beads are | |
| added as dispersion media to each can. The cans are | |
| placed on a paint shaker off-center and shaken for 45 | |
| minutes. | |
| Reduction: The following ingredients are added to the | |
| ink and shaken for 10 additional minutes. | |
| Methyl Ethyl Ketone | 30 |
| Toluene | 30 |

The ink is strained through a fine mesh paint strainer.
*Burnoc 18 472 resin is manufactured by Danippon Ink and Chemicals, Incorporated, Tokyo Japan.

The ink is then loaded into the Daetwyler instrument and the instrument run for 500,000 revolutions. Once the test is complete, the Daetwyler instrument is disassembled and the substrate weighed after cleaning thoroughly. The abrasion of the TiO₂ sample used to prepare the ink is recorded as the substrate weight loss after the test.

In one embodiment, the low abrasion TiO₂ pigments produced as described herein can be used in the surface coating of metal cans. Typically, metal containers are made using one of two processes, the two-piece can process and the three-piece can process. Using the two-piece can processes, for example, large rolls of aluminum sheet stock are continuously fed into a press (cupper) that forms a shallow cup. The cup is drawn and wall-ironed to form the body of the beverage can. The lid is attached after the can is filled with product.

Can exteriors are often roll-coated with a neutral color, for example white or grey, which is then oven-cured. Decorative inks are then put on, for example, with a rotary printer, and a protective varnish is roll-coated directly over the inks, then oven cured again.

Can interiors are spray-coated with “inside spray” using an airless spray nozzle. Inside sprays are again oven-cured or baked.

Steel tuna fish-style cans and traditionally-shaped food cans can also be made using the two-piece process.

The three-piece can process includes traditional steel food cans, pails, and drums. These cans are those, for example, that are opened either at the top or the bottom with a can opener. A rectangular sheet (body blank) is rolled onto a cylinder and soldered, welded, or cemented at the seam. One end is attached after the filling of the can with product.

In other embodiments, the low abrasion TiO₂ pigments can be used in printing ink processes. Table 2 below summarizes major end use applications of printing inks, by major substrate and printing process.

TABLE 2
Printing Ink Processes (by Substrate and End Use)

| | Primary Printing | |
|---|---|---|
| Type of Substrate | Process | End Uses |
| Plastic Films | Flexo, Gravure | Flexible Packaging |
| Containerboard | Flexo, Letterpress | Corrugated Containers |
| Metal Foil | Flexo, Gravure | Flexible Packaging |
| Paperboard boxboard | Lithography, Gravure | Folding cartons, food |
| | | containers |
| Plastic | Lithography, Flexo | Containers |
| Coater papers | Lithography, Gravure | Magazines, catalogs, |
| | | labels |
| Uncoated papers | Lithography, | Books, directories, |
| | Letterpress | commercial print |
| Newsprint | Lithography, | Newspapers, |
| | Letterpress | supplements |
| Glass | Screen | Containers |
| Aluminum | Lithography | Containers |
| Textiles | Screen, digital | Clothing |

White inks are primarily used in packaging applications. The dominant technologies for white ink packaging applications include Flexography and Gravure. These technologies are discussed further below.
Flexography

Process: Rubber image transfer plates. Some Flexographic products are capped, other not capped.

Applications include plastic film, plastic laminated paper compositions, thin metal foils and laminates of foil, plastic, and paper. However, a considerable portion of flexographic printing is for non-flexible packaging applications, including folding cartons and corrugated containers. Flexography is used to a smaller portion in the commercial printing market, such as, for example, for labels and business forms publications (e.g., books and catalogs), and in specialty applications such as, for example, gift wraps and wallpaper.

Formulations: Flexography inks are formulated to dry by absorption into the substrate or by solvent evaporation. The low viscosity inks are based on solvents such as, for example, water and alcohols, together with low levels of glycoethers, esters, and hydrocarbons. Film-forming polymers are, for example, polyamides, nitrocellulose, rosins, shellacs, and acrylics. Water-based flexo systems are used on absorbent paper surfaces such as, for example, Kraft corrugated containers and multiwall bags, and on films and foils. Solvent is used for plastic film, and water is used for paper products.

Gravure/Intaglio

Process: Engraved recessed cylinder.

Application: Gravure is a printing process primarily for large printers used in publication, packaging, and specialty gravure. Gravure printing produces high-quality graphics and is best suited for very long production runs.

Formulations: Publication gravure is solvent-based. Water-based printing inks hold more than half of the packaging gravure market. Heat treated titanium dioxide pigment may also be used in extruded polymer fibers. The polymer may be polyester, nylon or others. Heat treated titanium dioxide pigment is mixed with the polymer at elevated temperatures and extruded through a spinnerette to form a fiber. The pigment is contained in polymer fiber. Abrasion of the spinnerette orfice and other surfaces of the fiber producing equipment may occur with pigmented polymer. Pigments with reduced abrasion can provide reduce wear of the spinnerette.

Fibers can be made comprising the low abrasion TiO₂ pigments produced as described herein. Because the UV stabilization and hiding power of rutile TiO₂ is superior to that of anatase TiO₂, utilization of the low abrasion TiO₂ pigments described herein as fiber dyes provide fibers having the benefits of UV stabilization and hiding power along with desirable low abrasion.

Methods of dyeing fibers with TiO₂ pigments are well known to those skilled in the art and are disclosed in, e.g., Hanna T. R. & Subramanian N. S., “Rutile titanium dioxide for fiber applications”, 2004 Fibertech® Conference, Chattanooga, Tenn., which is incorporated herein by reference.

Suitable fibers into which the titanium dioxide pigments can be incorporated include, for example, natural fibers such as cellulose, cellulosic fibers, and rayon; polyolefins such as polyethylene and polypropylene; polyesters such as polycaprolactone (“PCL”), poly(ethylene terephthalate) (“PET”), poly(butylene terephthalate) (“PBT”), poly(trimethylene terephthalate) (Sorona®, E.I. du Pont de Nemours and Company) and a liquid crystal polymer (e.g., Vectran®, Kuraray Co.); polyamides such as nylon 6, nylon 11, nylon 12, and nylon 6,6; poly(ether-amides) such as, but not limited to, Pebax® 4033 SA and Pebax® 7233 SA (Arkema Corp.); poly(ether-esters) such as, but not limited to, Hytrel® 4056 (E.I. du Pont de Nemours and Company) and Riteflex® (Hoechst-Celanese); fluorinated polymers such as poly(vinylidine fluoride) and poly(tetrafluoroethylene); and combinations thereof, including bicomponent fibers, which may be core-sheath fibers. Texturized fibers can also be used. The bicomponent fibers can have cross-sectional shapes such as round; trilobal; cross; and others known in the art.

The core-sheath bicomponent fibers are typically made such that the sheath of the fibers utilizes a lower melting point polymer than the core polymer. Suitable polymers for the core include polyamides such as, but not limited to, nylon 6, nylon 11, nylon 12, and nylon 6,6; polyesters such as, but not limited to, PET and PBT; poly(ether-amides) such as, but not limited to, Pebax® 4033 SA and Pebax® 7233 SA; poly(ether-esters) such as, but not limited to, Hytrel® 4056 and Riteflex®; polyolefins such as, but not limited to, polypropylene and polyethylene; and fluorinated polymers, such as, but not limited to, poly(vinylidene fluoride); and mixtures thereof. Suitable polymers for the sheath include polyolefins such as, but not limited to, polyethylene and polypropylene; polyesters such as, but not limited to, PCL; poly(ether-amides) such as, but not limited to, Pebax® 4033 SA and Pebax® 7233 SA; poly(ether-esters) such as, but not limited to, Hytrel® and Riteflex®; elastomers made from polyolefins, for example Engage® elastomers (DuPont Dow Elastomers LLC); poly(ether urethanes) such as, but not limited to, Estane® poly(ether urethanes) (BF Goodrich); poly(ester urethanes) such as, but not limited to, Estane® poly(ester urethanes); Kraton® polymers (Shell Chemical Company) such as, but not limited to poly(styrene-ethylene/butylene-styrene); and poly(vinylidene fluoride) copolymers, such as, but not limited to, Kynarflex 2800, (Elf Atochem). The ratio of the two components of the core-sheath fibers can be varied. All ratios used herein are based on volume percents. The ratio may range from about 10 percent core and about 90 percent sheath to about 90 percent core and about 10 percent sheath, preferably from about 20 percent core and about 80 percent sheath to about 80 percent core and about 20 percent sheath, more preferably from about 30 percent core and about 70 percent sheath to about 70 percent core and about 30 percent sheath.

Methods of adding TiO₂ pigments to paper as fillers and/or coating pigments are well known in the art (see, e.g., Pigments for Paper: Titanium Dioxide, Hagemeyer R. W. ed., pp. 157-86, TAPPI Press, Atlanta, Ga., incorporated herein by reference). The paper is usually prepared from a mixture of water, cellulose fibers, and the low abrasion titanium dioxide pigments disclosed herein, optionally in the presence of an agent for improving the wet strength of the paper. An exemplary agent for improving the wet strength is a quaternary ammonium salt of epichlorohydrin-based polymers (for example epichlorohydrin/dimethylamine polymers).

There are many different grades of paper made, thus requiring a range of pigment content, from about 1% to 25% by weight on a dry basis. When titanium dioxide is added to paper, it may account for about 1% to 10% or more of the weight of the paper depending on the desired improvement in opacity.

Another aspect relates to the use of the low abrasion titanium dioxide pigments disclosed herein in the production of paper laminates based on paper containing the low abrasion titanium dioxide pigment and at least one resin (in particular a melamine or melamine-formaldehyde resin). Any paper laminate production process known to those skilled in the art may be employed (using a paper pigmented with the low abrasion titanium dioxide pigment disclosed herein) in order to prepare the laminates. The disclosure herein is not limited to one specific production process. Thus, for example, the pigmented paper may be impregnated with an aqueous-alcoholic solution of resin, after which several sheets of pigmented paper impregnated with resin are laminated by hot-pressing techniques. The pigmented paper may contain an agent for improving the wet strength of the paper.

### EXAMPLES

### Example 1

Pigmentary TiO2 was Derived from a TiCl4 Oxidation Process in which 0.2 wt % AlCl3 was Added as a Co-Oxidant

TiCl₄ vapor containing vaporized AlCl₃ was heated and continuously admitted to the upstream portion of a vapor phase reactor of the type described in U.S. Pat. No. 3,203,763. Simultaneously, oxygen was heated to about 1540° C. and admitted to the same reaction chamber through a separate inlet. Aluminum chloride was added at a rate sufficient to produce approximately 0.2 wt % Al₂O₃ associated with the pigment TiO₂ in the collected oxidation reactor discharge. The reactant streams were rapidly mixed. The gaseous suspension of TiO₂ was then quickly cooled in the flues. The titanium dioxide pigment was separated from the cooled gaseous products by conventional means.

275 g of pigment was loaded in a ceramic boat and placed into a furnace equipmed with a 4″ diameter quartz tube. The tube was purged with approximately 0.95 liter/minute of nitrogen for 12 hours.

The flow rate was reduced to 0.35 liter/minute and the material was heated to 1000° C. over 3.25 hours. The sample was soaked at 1000° C. for 5 hours before being allowed to cool to room temperature.

250 g of this material was formulated into an ink according to the following procedure. A Daetwyler test was used to measure the abrasivity of the pigment.

### Comparative Example 1

The same procedure was followed as described in example 1, except that the pigment was not heated in the inert atmosphere.

### Example 2

TiCl₄ vapor containing vaporized AlCl₃ was heated and continuously admitted to the upstream portion of a vapor phase reactor of the type described in U.S. Pat. No. 3,203,763. Simultaneously, oxygen was heated to about 1540° C. and admitted to the same reaction chamber through a separate inlet. Aluminum chloride was added at a rate sufficient to produce approximately 1.1% Al₂O₃ associated with the TiO₂ in the collected oxidation reactor discharge. The reactant streams were rapidly mixed. The gaseous suspension of TiO₂ was then quickly cooled in the flues. The titanium dioxide pigment was separated from the cooled gaseous products by conventional means.

The same procedure as described in Example 1 was used to create the heated pigment.

### Comparative Example 2

The same procedure was followed as described in example 2, except that the pigment was not heated in the inert atmosphere. Results are shown in Table 3.

TABLE 3

| | substrate abrasion |
|---|---|
| Example # | (mg) |
| Example 1 | 8.58 |
| Comparative 1 | 19.48 |
| Example 2 | 46.92 |
| Comparative 2 | 74.56 |

As illustrated by Examples 1 and 2, heat treatment of TiO₂ pigment in N₂ has resulted in a large decrease in the abrasiveness of the pigment, as measured by the substrate abrasion in the Daetwyler test.

What is claimed is:

1. A process comprising:
a) Heating particles of titanium dioxide to 800 to 1200° C. for about 5 to 24 hours in an atmosphere comprising a non-oxidizing gas to form a heat treated pigment.
b) mixing said heat treated pigment with other ink components to form an ink.

2. The process of claim 1 wherein the non-oxidizing gas is selected from nitrogen, argon, and helium.

3. The process of claim 1 further comprising:
c) applying said ink to an engraved plate containing a pattern to form an inked, engraved plate
d) pressing a substrate against said inked, engraved plate to transfer a pattern of ink to said substrate
e) separating said substrate from said inked, engraved plate
f) drying said pattern of ink.

4. A process of claim 1 further comprising:
c) depositing drops of said ink on a substrate
b) drying the drops of ink.

5. A process of claim 1, wherein said titanium dioxide is prepared by a method comprising:
(i) heating TiCl₄ to temperatures of 300 to 650° C.
(II) mixing the TiCl₄ with volatile aluminum halides such as AlCl₃, AlBr₃, and AlI₃, in amounts sufficient to provide between 0.2 and 10 wt % Al₂O₃ in the final pigment
(ii) reacting TiCl₄ with oxygen in the presence of aluminum halide

6. A pigment made by the process of claim 1.

7. A process comprising:
g) applying an ink made according to the process of claim 1 to an engraved plate containing a pattern to form an inked, engraved plate
h) pressing a substrate against said inked, engraved plate to transfer a pattern of ink to said substrate
i) separating said substrate from said inked, engraved plate
j) drying said pattern of ink.

8. A process comprising:
a) depositing drops of the ink of claim 1 on a substrate
b) drying the drops of ink.
a) heating particles of titanium dioxide to 800 to 1200° C. for about 5 to 24 hours in an atmosphere comprising a non-oxiding gas to form a heat treated pigment
b) mixing said heat treated pigment with a polymer to form a pigmented polymer, and
c) extruding said pigmented polymer through a spinnerette to form a fiber.

9. The process of claim 9 wherein the non-oxidizing gas is selected from the group consisting of nitrogen, argon and helium.
